(19) United States
(12) Patent Application Publication
(10) Pub. No.: US 2014/0214264 A1
(43) Pub. Date: Jul. 31, 2014

(54) COORDINATED DATA TRANSMISSION TRIGGERS

(71) Applicant: Caterpillar Inc., Peoria, IL (US)

(72) Inventors: Michael J Campagna, Chillicothe, IL (US); Ryan N CHURN, Peoria, IL (US)

(73) Assignee: Caterpillar Inc., Peoria, IL (US)

(21) Appl. No.: 14/228,714

(22) Filed: Mar. 28, 2014

(51) Int. Cl. G07C 5/00

(52) U.S. Cl. CPC G07C 5/008
USPC 701/32.3

(57) ABSTRACT

A system to provided coordinated data transmission triggers is disclosed. The system may be termed as Vital Information Management System (VIMS). The VIMS may operate on the basis of certain data transmission triggers. The VIMS may further use a cellular, satellite or Wi-Fi network for the wireless communication of vehicle information. The data transmission triggers may include data transmission triggers based on time and/or time independent data transmission triggers. Examples of the data transmission triggers may be a trigger based on vehicle speed parameter, a trigger based on proximity to specified location(s) and the like. The time based data transmission triggers may send the one or more data signals after a predefined time interval. Whereas the time independent data transmission triggers may send one or more data signals as soon as the event associated with the data transmission triggers is satisfied.

### TECHNICAL FIELD

The present disclosure relates generally to a vital information management system (VIMS) for communicating information associated with a vehicle. More specifically, the present disclosure relates to the VIMS based on coordinated data transmission triggers.

### BACKGROUND

Vehicle manufacturers use wireless communication technology in vehicles quite extensively. Application of wireless communication technology to diagnose vehicles from a remote location has improved maintenance process of vehicles. Various data gathering systems may be used to collect data associated with state or condition of monitored vehicles. The collected data may be transmitted to a central office system. The central office system monitors the vehicles based on the transmitted data. The monitoring of the vehicles and the associated data transmission is achieved by the use of telematics system. One such system which may be utilised to monitor a vehicle remotely is a Vital Information Management System (VIMS).

VIMS may include various components to collect data related to the vehicle performance. VIMS may collect several types of data, for example, data regarding change in temperature of radiator coolant, change in the vehicle speed, fuel injection frequency, location, and the like. VIMS may transmit the collected data to the central office system after predefined time intervals or initiated in real time. VIMS may transmit the collected data through a wired or wireless communication network, such as a Wi-Fi network, cellular network, and the like.

However, the existing VIMS experiences various challenges such as disrupted signal, loss of collected data and error in communication. Consequently, collected data may be disrupted and may require being re-attempted. After a defined number of attempts, the data push stops. Hence, a very less percentage of the collected data is actually transmitted to the central office system. For example, data loss may occur when the vehicle is out of reliable signal range. In another example, data loss may also occur when the vehicle is in an area lying below the horizon, at a mining site, and the similar cases. This data loss may lead to errors in the data received by central office system which further hampers the efficiency of the VIMS. Also, the collected data is stored in a memory module by VIMS and may be over written after a predefined time interval. Hence, the data may be lost when the vehicle is out of range of its communication channel and is unable to transmit information.

### SUMMARY OF THE DISCLOSURE

The present disclosure provides a vital information management system (VIMS) to provide coordinated data transmission triggers for communicating information associated with a vehicle. The VIMS includes a sensing system, a transmitter, and a controller. The sensing system is operable to collect the vehicle information associated with the vehicle to be monitored. The transmitter transmits one or more data signals associated with the collected vehicle information to the central office system. The controller determines occurrence of at least one data transmission trigger. The at least one data transmission trigger indicate a condition for transmitting the collected vehicle information. Further, the controller commands the transmitter to transmit the one or more data signals associated with the collected vehicle information based on the occurrence of the at least one data transmission trigger. The at least one data transmission trigger may include one or more of: vehicle speed, proximity of the vehicle to a specified location, entry or exit of the vehicle from a geo-fence, location of the vehicle relative to a way-point, strength of a communication network available to transmit the collected vehicle information, activation of an engine fault code or a vehicle loading event, direction of travel of the vehicle, and a preference of an operator associated with the vehicle.

### BRIEF DESCRIPTION OF THE DRAWINGS

FIG. 1 illustrates an exemplary environment in which the present disclosure can be implemented in accordance with the concepts of the present disclosure;

FIG. 2 illustrates an exemplary vital information management system(VIMS) in accordance with the concepts of the present disclosure; and

FIG. 3 is a flow chart illustrating a method for monitoring vehicle in accordance with the concepts of the present disclosure.

### DETAILED DESCRIPTION

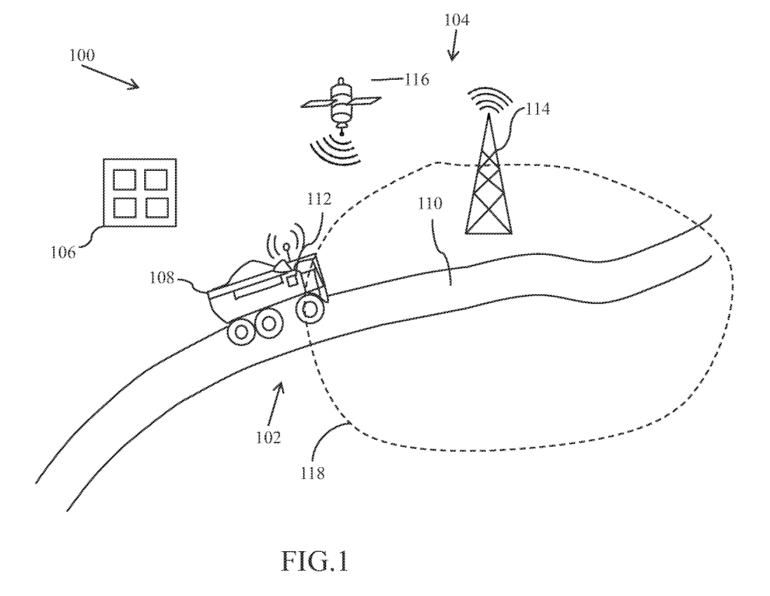

FIG. 1 illustrates an exemplary environment 100 in which the present disclosure can be implemented in accordance with the concepts of the present disclosure. The environment 100 comprises a worksite 102, a network system 104, and a central office system 106.

The worksite 102 comprises a vehicle 108 and a path 110. The vehicle 108 comprises a vital information management system (VIMS) 112. The worksite 102 may be a mine site, a landfill, a quarry, a construction site, a logging site, a road worksite, or another type of worksite known in the art.

The vehicle 108 may be an autonomous, a semi-autonomous, and/or a manually controlled vehicle. Although the autonomous vehicle may be designed to operate without an operator, it should be understood that autonomous vehicles may or may not be designed to operate with an operator. In one embodiment, the vehicle 108 may be a motor grader, an excavator, a dozer, a haul truck, a water truck, a wheel loader, a tracked loader, a compactor, a scraper, or another type of industrial vehicle. The vehicle 108 may perform various operations such as mining, construction, farming, grading, quarry, landfill compacting, forestry, and the like. The type of the vehicle 108 may depend on the type of worksite 102 in which the vehicle 108 is to be used.

In one embodiment, the path 110 may be a path comprising hilly terrain, mining sites, path with rock inclusions, and the like. The path 110 may be an uphill path, where the vehicle 108 has to move against the gravitational pull. Hence, the vehicle 108 may require more traction force as compared to that on a horizontal path. Similarly, in another embodiment the path 110 may be a downhill path where the gravitational force supports the motion of the vehicle 108. Hence, the vehicle 108 may require a retarding force during its travel for a controlled motion of the vehicle 108. The vehicle 108, during its operation at the worksite 102 may travel over the path 110 many a time. The terrain of the path 110 at the worksite 102 may have an impact on the performance of the vehicle 108 at the worksite 102.

When the vehicle 108 performs its operation at the worksite 102, the VIMS 112 may continuously monitor vehicle information regarding various parameters. These parameters may be associated with performance of the vehicle 108. Examples of such parameters may include, but are not limited to, engine data, coolant temperature, ground speed, vehicle speed/load ratio, transmission speed, brake pressure, fuel injection rate and the like. The vehicle information regarding various parameters of the vehicle 108 may be monitored by the VIMS 112 and may depend on the worksite 102. In an example, the VIMS 112 may monitor engine speed while the vehicle 108 is traversing uphill on the path 110.

The VIMS 112 may collect vehicle information about various parameters associated with the vehicle 108. Further, the VIMS 112 may transmit the vehicle information to the central office system 106 via the network 104. The collected vehicle information may be transmitted in the form of one or more data signals associated with the vehicle information through the network 104. The network 104 may be capable of carrying the one or more data signals between a source and a destination. For example, the source can be VIMS 112 of the vehicle 108 and the destination can be the central office system 106. The network 104 may be a wired and/or wireless communication network. Examples of the network 104 may include, but not limited to a cellular network, a satellite network and/or a Wi-Fi network.

It may be noted that the network 104 may have a specific range or coverage area. Specifically, the network 104 can be distributed over the worksite 102 into regions called cells. Each region or cell is served by at least one fixed-location transceiver, such as base station 114 or a geo-stationary satellite transceiver such as satellite 116. The base station 114 and satellite 116 may not cover the entire worksite 102. Hence, there may be regions in the worksite 102 which are not served by the base satiation 114 or satellite 116. For example, the base station 114 may not cover area beyond its specific range 118. Hence, this may lead to interruption in communication of data between the VIMS 112 and the central office system 106.

The VIMS 112 may be configured to enable transmitting of the collected vehicle information through the network 104 to the central office system 106.

The central office system 106 may be configured to receive the vehicle information from the VIMS 112 as the one or more data signals via the network 104. The one or more data signals may be associated with the vehicle information regarding various parameters of the vehicle. For example, the vehicle information may include the information on engine speed, monitored by the VIMS 112, while the vehicle is traversing on the path 110. The central office system 106 can be further configured to process the received vehicle information. Thereafter, the processed vehicle information may be used for graphical analysis, maintenance scheduling, chart formulation, creation of internal database for performance analysis, and the like. In an embodiment, the central office system 106 may process the received at least one data signals. In an alternate embodiment, the central office system 106 may transmit one or more data signals to the VIMS 112 to indicate the success or failure of the communication with the vehicle 108. For example, the central office system 106 may receive a data signal corresponding to the engine speed. The central office system 106 may interpret and process the received data signal and accordingly transmit a return data signal indicating successful receipt to the engine date to the VIMS 112.

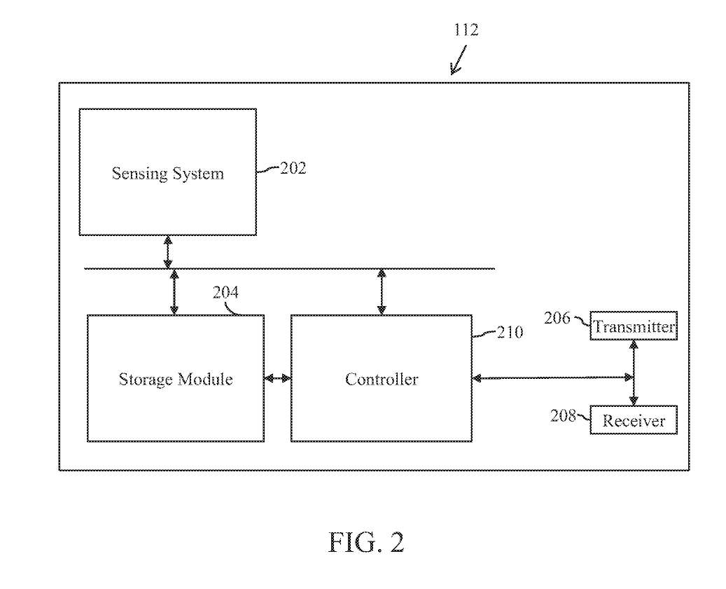

FIG. 2 illustrates an exemplary Vital Information Management System (VIMS) 112 in accordance with the concepts of the present disclosure. The VIMS 112 may include a sensing system 202, a storage module 204, a transmitter, 206, a receiver 208 and a controller 210. The sensing system 202, the storage module 204, the transmitter 206, the receiver 208, and the controller 210 may be in communication with each other.

The sensing system 202 can be operable to collect vehicle information. The vehicle information may be associated with the vehicle to be monitored, such as vehicle 108. The vehicle information may include engine data, coolant temperature, ground speed, vehicle speed/load ratio, exhaust temperature, fuel injection rate, activation of an engine fault code and the like. The sensing system 202 may be a system with one or more sensing elements configured to sense/detect changes in vehicle information. For example, the sensing system 202 may include a sensing element such as an oxygen sensor. The oxygen sensor may sense and collect values of concentration of oxygen in exhaust gas of an internal combustion engine. The sensing system 202 may collect the vehicle information and store the vehicle information in the storage module 204.

The storage module 204 may be configured to store vehicle information describing the condition of the vehicle 108. For example, the oxygen sensor may monitor the oxygen concentration and store the corresponding values of concentration in the storage module 204. In an embodiment, the storage module 204 can be a data repository, a data table, a matrix, or any other storage format known in the art that can be used to store and retrieve data. The stored vehicle information can be further transmitted to the central office system 106, via the transmitter 206.

The transmitter 206 may be operable to transmit one or more data signals associated with the collected vehicle information to the central office system 106. In an embodiment, the transmitter 206 may be an electronic device with an antenna configured to communicate wirelessly with the central office system 106. The transmitter 206 may transmit the one or more data signals associated with the collected vehicle information when the controller 210 commands the transmitter 206 to transmit vehicle information.

In an embodiment, the receiver 208 may be configured to receive the data signals from the central office system 106. The received data signals may be instructions from the central office system 106 based on the transmitted vehicle information. In other words, the VIMS 112 can communicate with the central office system 106 via the transmitter 206 and the receiver 208 over the network 104.

The controller 210 may be configured to retrieve the vehicle information from the storage module 204 and command the transmitter 206 to transmit the vehicle information to the central office system 106. Specifically, the controller 210 may control and communicate with the sensing system 202, the storage module 204, the transmitter 206, and the receiver 208. The controller 210 may be a microcontroller, a microprocessor, or any other similar controller known in the art. However, it is evident to a person with ordinary skill in the art that the type of the controller 210 used, nowhere affects the functionality of the present disclosure. The controller 210 may be configured to retrieve the stored vehicle information from the storage module 204 and thereafter may command the transmitter 206 to transmit the one or more data signals associated with the stored vehicle information to the central office system 106. Specifically, the stored vehicle information may be communicated to the central office system 106 based on a command from the controller 210. In one embodiment, the controller 210 may consist of a timer (not shown in Figure). The timer may trigger the controller 210 to communicate the stored vehicle information to the central office system 106 at a predefined time interval.

Further, the controller 210 may also determine occurrence of at least one data transmission trigger and command the transmitter 206 to transmit the stored vehicle information based on the occurrences of the at least one data transmission trigger. The at least one data transmission trigger may be criteria which need to be satisfied in order for the controller 210 to command the transmission of the one or more data signals to the central office system 106. For example the at least one data transmission trigger may be proximity of the vehicle 108 to a specific location at the work site 102. In one embodiment, a vehicle speed sensor may act as a sensing system 202 and may monitor the ground speed of the vehicle 108. Hence, the information related to vehicle ground speed may be stored by the sensing system 202 in the storage module 204. Further, the vehicle 108 may be approaching a geo fence. A geo fence may be a virtual boundary in a location detection scheme. In other words, the geo-fence may be a virtual radius around an area or point location or a predefined set of boundaries. In one embodiment, the geo-fence can be outer boundary of the coverage area such as 118 of the wireless network 104. As the vehicle approaches the geo-fence or the coverage area 118, the controller 210 may command the transmission of stored vehicle speed information to the central office system 106. Therefore the proximity of the vehicle 108 may act as at least one data transmission trigger.

The at least one data transmission trigger may be a time based data transmission trigger or a time independent data transmission trigger. A time based data transmission trigger may trigger transmission of vehicle information at the predefined time interval. Specifically, the controller 210 may command the transmitter 206 to transmit vehicle information at a predefined time interval when a time based data transmission trigger has occurred. On the other hand, the time independent data transmission triggers may not be triggered at a predefined time interval, but at the occurrence of a specific event. For example, the controller 210 may be configured to command the transmitter 206 to send the vehicle information at regular interval of one hour based on the timer. Hence, the time dependent data trigger may be interval of one hour. Whereas, the time independent data transmission triggers may be independent of the time based event. Vehicle speed, proximity of the vehicle to a specified location, entry or exit of the vehicle from a geo-fence, location of the vehicle relative to a way-point, strength of a communication network available to transmit the collected vehicle information, activation of an engine fault code or a vehicle loading event, direction of travel of the vehicle, and/or a preference of an operator associated with the vehicle may serve as example events for time independent data transmission triggers. Hence, a time independent data transmission triggers may cause the transmission of vehicle information at the occurrence of such an event, even when the predefined time interval has not elapsed.

The controller 210 may command the transmitter 206 to transmit the one or more data signals associated with the collected vehicle information based on the occurrence of time independent data transmission triggers. The above mentioned criteria may be further elaborated with the help of a few examples such as the geo-fence or coverage area 118. As shown in FIG. 1, when the vehicle 108 enters or exits a the boundary of the coverage area 118, the controller 210 may determine the occurrence of the at least one data transmission trigger and command the transmitter 206 to transmit one or more data signals regarding vehicle information.

In another embodiment, we can consider the example related to the waypoints. Waypoints are sets of coordinates that identify a point in physical space. The transmitter 206 may transmit a signal when the vehicle 108 is at a particular location with respect to a waypoint. For example, the controller 210 may be configured to command the transmitter 206 to transmit one or more data signals when the vehicle 108 passes a certain bend in the path 110.

In yet another embodiment, if the vehicle 108 is moving with a velocity greater than a certain predetermined velocity, say 25 miles per hour, then the controller 210 may command the transmitter 206 to transmit one or more data signals associated with the speed of the vehicle.

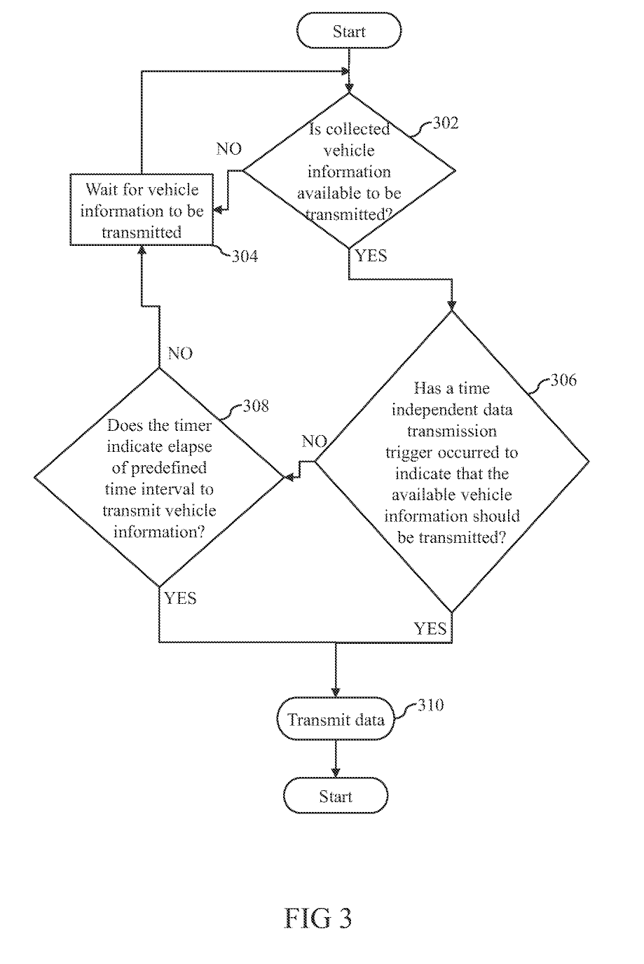

In another embodiment, the controller 210 after receiving vehicle information from the storage module 204 may check for the occurrence of a time based data transmission trigger. In general, the transmitter 206 may transmit vehicle information after a predefined time interval, say 1 hour on the basis of the time based trigger. However, the controller 210 may command the transmitter 206 to transmit vehicle information before the predefined time interval if the controller 210 determines the occurrence of at least one time independent data transmission trigger. The process of data transmission for transmitting vehicle information is further described with reference to FIG. 3.

In an embodiment, the central office system 106 sends a signal to the controller 210 of the VIMS 112. The controller 210 may receive the signal when the vehicle 108 is in the specific range 118. The controller 210 after receiving the signal may command the transmitter 206 to transmit the vehicle information. The vehicle information may be transmitted in any way discussed in above embodiments.

FIG. 3 is a flow chart 300 illustrating a method for monitoring vehicle. At step 302, the controller 210 may check whether the collected vehicle information is available to be transmitted. At step 304, the controller 210 may choose to wait if the collected vehicle information is not available to be transmitted. Further, at step 306 the controller 210 may check for the occurrence of one or more time independent data transmission trigger if the collected vehicle information is available for transmitting. At step 308 the controller 210 may check, with the help of a timer, if the predefined time interval has elapsed to transmit vehicle information, when the time independent data transmission trigger has not occurred. A timer is a specialized clock for measuring and indicating specified time intervals. For example, if a timer is set for one hour, then as the timer indicates completion of one hour interval and the controller 210 may command the transmitter 206 to transmit the collected vehicle information. Hence, the controller 210 may command to transmit the one or more data signals corresponding to the collected vehicle information to the control unit 106 at step 310.

The controller 210 may command the transmitter 206 to transmit the one or more data signals corresponding to the collected vehicle information if it has determined the concurrence of one or more of the time independent data trigger or the timer indicates the time to transmit the collected vehicle information. At step, 310 the controller 210 may command to transmit the one or more data signals corresponding to the collected vehicle information, when the time independent data transmission trigger has occurred at step 306. The time independent data transmission triggers may be vehicle speed, proximity of the vehicle to a specified location, entry or exit of the vehicle from a geo-fence, location of the vehicle relative to a way-point, strength of a communication network available to transmit the collected vehicle information, activation of an engine fault code or a vehicle loading event, direction of travel of the vehicle, and/or a preference of an operator associated with the vehicle. Alternatively, at step 304 the controller 210 may wait until it detects the availability of collected vehicle information to be transmitted, if neither the timer nor the time independent data transmission trigger indicates to transmit the vehicle information. Thereafter the transmitted vehicle information may be used by the central office system 106 for various functions such as chart formulation, creation of internal database for various analyses, to diagnose the vehicle for controlling various vehicle parameters and the like.

### INDUSTRIAL APPLICABILITY

The central office system 106 uses a system based on data transmission triggers for communicating with the vehicle 108. The controller 210 commands the transmitter 206 to transmit the collected vehicle information at a predefined time interval say after one hour based on the time dependent trigger. However, if the controller 210 detects the presence of a time independent trigger in the meanwhile, the controller 210 may command the transmitter 206 to transmit the collected vehicle information before the predefined time interval has elapsed. This process results in less interrupted data transmission and reduced loss of data which in turn, helps in diagnosing the vehicle with a better consistency. The idea for the present disclosure is of great importance in the vehicles used for operating at the worksites such as a mine site, a landfill, a quarry, a construction site, a logging site, a road worksite, or another type of worksite known in the art. The present disclosure provides a continuous and consistent data transmission. Data losses may be reduced to a great extent. The present disclosure may also result in reduced cost of data transmission.

What is claimed is:

1. A Vital Information Management System (VIMS) to provide coordinated data transmission triggers for communicating information associated with a vehicle wherein the VIMS comprises:
a sensing system operable to collect vehicle information associated with the vehicle to be monitored;
a transmitter operable to transmit one or more data signals associated with the collected vehicle information to a central office system; and
a controller operable to:
determine occurrence of at least one data transmission trigger, wherein the at least one data transmission trigger indicates a condition for transmitting the collected vehicle information; and
command the transmitter to transmit the one or more data signals associated with the collected vehicle information based on the occurrence of the at least one data transmission trigger, wherein the at least one data transmission trigger comprises at least one of:
vehicle speed,
proximity of the vehicle to a specified location,
entry or exit of the vehicle from a geo-fence,
location of the vehicle relative to a way-point,
strength of a communication network available to transmit the collected vehicle information,
activation of an engine fault code,
a vehicle loading event,
direction of travel of the vehicle, and/or
a preference of an operator associated with the vehicle.
